(19) United States
(12) Patent Application Publication
(10) Pub. No.: US 2006/0119514 A1
(43) Pub. Date: Jun. 8, 2006

(54) Radio signal direction finder

(76) Inventors: John Pritchard, Malvern (GB); Andrew Martin Gardner, Malvern (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/541,665

(22) PCT Filed: Jan. 7, 2004
(86) PCT No.: PCT/GB04/00012

§ 371 Date: Jan. 17, 2006

(30) Foreign Application Priority Data
Jan. 8, 2003 (GB) 0300352.2

(51) Int. Cl. G01S 3/52; G01S 5/04

(52) U.S. Cl. 342/418; 342/442

(57) ABSTRACT

A radio direction finding (RDF) receiver using an array of receiving antennas for known signals with a relatively large frequency uncertainty is described. Additional sensitivity for low signal to noise environments, compared to a conventional receiver used for direction of arrival (DOA) measurements, is obtained. This is achieved by using the outputs of all the receiving antennas combined to provide coherent signal to noise gain, but without the associated increased directivity of the larger aperture.

The invention concerns a method and apparatus for determining the direction of ARRIVAL (DOA) of a radio signal. It has utility in situations there information concerning the transmitted waveform is known (particularly the cycle time and bandwidth) and where the signal to noise ratio is low, for example in search and rescue operations. Both azimuth and elevation DOA may be determined.

The term “cycle time” is intended to mean the time it takes for a repeating modulated signal to repeat itself.

According to the present invention a method of direction finding for radio signals of known bandwidth and cycle time comprises the steps of:

receiving the radio signals on an array of at least three antennas to provide a corresponding number of signal channels;

correlating, for each channel, one or more complete modulation cycles of the signal with the next modulation cycles;

summing the correlated signals so obtained;

determining the frequency of the radio signal of interest from the sum of the correlated signals;

mixing the frequency so determined with the uncorrelated channel signals to produce a narrow bandwidth signal commensurate with the modulation of the radio signals and

applying phase detection and direction finding routines to the narrow bandwidth signals.

A preferred embodiment further includes the step of mixing the received signals to an intermediate frequency (IF) suitable for further processing, prior to correlation of the modulation cycles.

According to a second aspect of the invention, apparatus for direction finding for radio signals of known modulation comprises an array of at least three antennas arranged to receive the radio signals of interest and provide a corresponding number of signal channels;

means for correlating, for each channel, one or more complete modulation cycles of the signal with the next modulation cycle;

means for summing the correlated signals so obtained;

means for determining the frequency of the radio signal of interest from the sum of the correlated signals;

means for mixing the frequency so determined with the uncorrelated channel signals to produce a narrow bandwidth signal commensurate with the modulation of the radio signals and

processing means for applying phase detection and direction finding routines to the narrow bandwidth signals.

In a preferred embodiment, said apparatus further including means for mixing the received signals to an intermediate frequency (IF) suitable for further processing, prior to correlation of the modulation cycles.

The apparatus of the invention works in two phases: first frequency detection and then angle of arrival determination. In the frequency detection phase, additional sensitivity is obtained, compared to a conventional directional receiver, by using the outputs of all the receiving antennas combined in a certain way, but without the associated increased directivity of the larger aperture. Increased directivity is undesirable since this would require the antenna array to be scanned to cover 380°. By the present invention, so long as the noise in each channel is uncorrelated, defined increases in sensitivity may be obtained via coherent addition, by increasing the number of antennas and receiving channels. That is for N channels the signal to noise ratio will increase by N. At frequencies where atmospheric noise is low, that is at VHF and above, the noise in each channel will be largely uncorrelated, since each channel will posses separate noise sources from lossy and active devices which will dominate over the common atmospheric noise.

The invention will now be described with reference to the following figures in which:

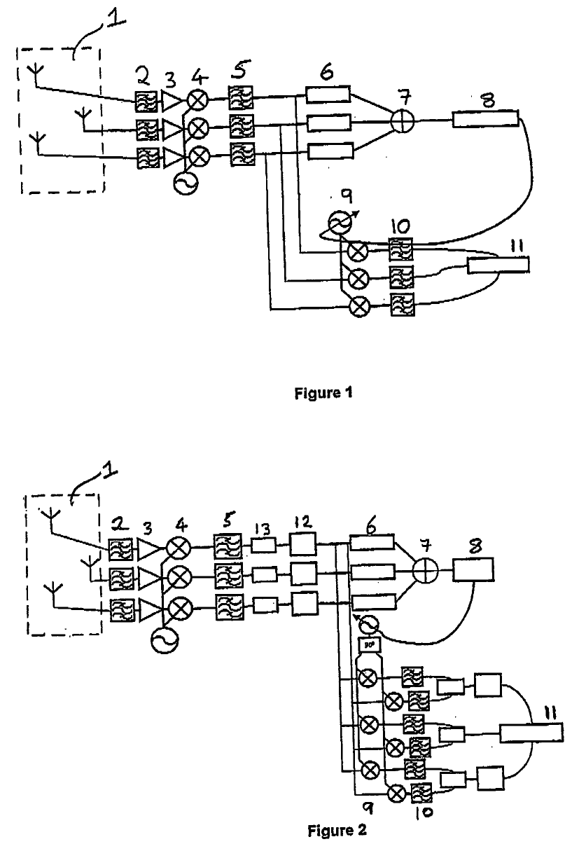

FIG. 1 shows a schematic representation of a three-channel implementation of the invention and

FIG. 2 shows another representation disclosing greater detail of how direction of the signal might be determined from the processed data.

Referring to FIG. 1, signal incident upon an antenna array I is passed through filters 2 to remove out of band interference and noise, and also to reject the image frequency caused by the mixing stage.

The signal is then amplified by a low noise amplifier (LNA) 3 and mixed to a suitable lower intermediate frequency (IF) at mixer 4 to facilitate further processing. Additional filters 5 reduce unwanted mixing products.

Correlators 6 correlate one complete modulation cycle with the next to effectively remove the phase information present between the channels. The correlated signals are then summed at 7 (thus realising coherent signal to noise gain) before conventional detection routines, familiar to a person skilled in the art are applied at processing means 8 to detect the signal of interest in the frequency domain.

Once the exact frequency of the signal of interest has been determined this information is used to slave a local oscillator 9 to force the signals to appear within the bandwidth of the next filters 10 which further reject noise and interference. These filters are set to the bandwidth of the modulation which is known a priori. Conventional phase detection and direction finding routines are then applied to the resulting signals at processing means 11.

Referring to FIG. 2. The down-conversion and band selection circuits convert the received RF signal to a suitable IF where correlation can take place. The First IF is necessarily removed from the final IF in frequency to enable rejection by final IF filters. The bandwidth is that of the full uncertainty bandwidth of the signal. Once frequency detection has taken place, the bandwidth is suitably narrowed to that of the modulation, thus removing noise from the phase detection and direction finding algorithms.

Where the uncertainty bandwidth allows digital techniques are conveniently used for all the detection processing. This greatly reduces channel to channel variation and allows convenient calibration. To calibrate the system a known signal is fed into the antennas and the scale and phase adjusted accordingly 12.

Angular information may be extracted using I and Q processing and the arctan function as shown in FIG. 2. Alteratively the vector scalar product in IQ space between two channel signals may be used to derive three phase differences. The latter approach approach is more reliable at certain DOA where the arctan function is sensitive to noise.

Other phase detectors could be used but I and Q processing removes the amplitude dependency of the result and therefore eliminates the requirement for an Automatic Level Control System (ALC) system (in the latter approach of the previous paragraph, the ALC is effectively included in the modulus calculation).

The frequency detection block is based upon the Fast Fourier Transform (FFT) and as such will not present the exact frequency of the input. Thus the output of the arctan function will contain two components: the phase of the wanted signal compared to the ADC clock 13 and a linear ramp of phase due to the detected frequency not being exact. However the difference of the arctan outputs gives the required angle and the linear ramp cancels since it is common.

1. A method of direction finding for radio signals of known bandwidth and cycle time comprising the steps of:
receiving the radio signals on an array or at least three antennas to provide a corresponding number of signal channels;
correlating, for each channel, one or more complete modulation cycles of the signal with the next modulation cycle;
summing the correlated signals so obtained;
determining the frequency of the radio signal of interest from the sum of the correlated signals;
mixing the frequency so determined with the uncorrelated channel signals to produce a narrow bandwidth signal commensurate with the modulation of the radio signals and
applying phase detection and direction finding routines to the narrow bandwidth signals.

2. The method of claim 1, further including the step of mixing the received signals to an intermediate frequency (IF) suitable for further processing, prior to correlation of the modulation cycles.

3. Apparatus for direction finding for radio signals of known bandwidth and cycle time comprising an array of at least three antennas arranged to receive the radio signals of interest and provide a corresponding number of signal channels;
means for correlating, for each channel, one or more complete modulation cycles of the signal with the next modulation cycle;
means for summing the correlated signals so obtained;
means for determining the frequency of the radio signal of interest from the sum of the correlated signals;
means for mixing the frequency so determined with the uncorrelated channel signals to produce a narrow bandwidth signal commensurate with the modulation of the radio signals and
processing means for applying phase detection and direction finding routines to the narrow bandwidth signals.

4. The apparatus of claim 3, further including means for mixing the received signals to an intermediate frequency (IF) suitable for further processing, prior to correlation of the modulation cycles.
